(19) United States
(12) Patent Application Publication
(10) Pub. No.: US 2026/0238050 A1
(43) Pub. Date: Aug. 13, 2026

(54) Stator with Slot Bridges

(71) Applicant: BorgWarner Inc., Auburn Hills, MI (US)

(72) Inventors: Cong Ma, Fishers, IN (US); Keyu Chen, Fishers, IN (US)

(21) Appl. No.: 19/050,629

(22) Filed: Feb. 11, 2025

(51) Int. Cl. H02K 1/16

(52) U.S. Cl. CPC H02K 1/165

(57) ABSTRACT

A stator for an electric machine includes a stator core and a winding arrangement provided on the stator core. The stator core defines an axial direction, a first end, and a second end of the stator. The stator core includes an outer diameter wall and a plurality of teeth extending radially inward from the outer diameter wall with a plurality of slots defined between the teeth. A plurality of bridges are positioned in the plurality of slots, each of the plurality of bridges extending across a circumferential width of an associated slot. All of the outer diameter wall, the plurality of teeth, and the plurality of bridges are comprised of a magnetic permeable material. The winding arrangement includes a plurality of conductors positioned in the slots, each of the plurality of conductors positioned radially outward from one of the plurality of bridges in the associated slot.

### FIELD

The present disclosure relates to the field of electric machines, and more particularly, stator arrangements for electric machines.

### BACKGROUND

Many electric motors are designed to operate within a wide range of speeds. These motors may experience significant AC loss during operation, resulting in an inefficient electric machine. These motors may also experience undesirable noise, vibration and harshness (NVH), further contributing to inefficiencies and problems with the electric machine. AC losses and NVH issues are commonly experienced in many electric motors, including interior permanent magnet (IPM) machines.

An exemplary rotor and stator arrangement for an IPM machine 110 is shown in FIG. 8. FIG. 8 only shows a limited portion (i.e., a 45° span) of the rotor and stator arrangement for the sake of simplicity. As shown in FIG. 8, the IPM electric machine 110 includes a rotor 112 with a plurality of permanent magnets 114 embedded in cavities of the rotor 112. The rotor 112 is surrounded by a stator 120. The stator 120 includes a stator core 122 with a winding arrangement 130 arranged thereon. The stator core 122 includes plurality of teeth 124 with slots 126 formed between the teeth 124. Conductors of the winding arrangement 130 extend through the slots 126 of the stator core 122. Electric current flowing through the winding arrangement 130 causes the rotor 112 to rotate about a center axis 11.

IPM motors have high core loss even at no-load, non-operating conditions. The core losses act as extra drag losses in addition to mechanical loss. The no-load core loss in an IPM motor can be as much as 60% of the total drag loss. At high speed, AC copper loss and core loss are typically dominant losses that tend to reduce the high-speed continuous power of the motor. High-speed continuous power is important for the performance of battery-powered electric vehicles (BEVs) and is often an important requirement for secondary drive units in BEVs.

A primary factor contributing to IPM motor noise is related to the structure of the stator. Improving the stiffness of the stator is one method that has proven beneficial in addressing motor noise. However, there remains a need to reduce motor noise even further.

In view of the foregoing, it would be desirable to provide an improved electric machine with features that improve motor performance by reducing high core losses within the machine. It would be particularly advantageous to reduce AC losses and reduce NVH within the electric machine. It would also be advantageous if the improved electric machine could be used in BEVs to assist in providing high-speed continuous power.

### SUMMARY

In at least one embodiment, a stator for an electric machine includes a stator core and a winding arrangement provided on the stator core. The stator core defines an axial direction, a first end, and a second end of the stator. The stator core includes an outer diameter wall and a plurality of teeth extending radially inward from the outer diameter wall with a plurality of slots defined between the teeth. A plurality of bridges are positioned in the plurality of slots, each of the plurality of bridges extending across a circumferential width of an associated slot. All of the outer diameter wall, the plurality of teeth, and the plurality of bridges are comprised of a magnetic permeable material. The winding arrangement includes a plurality of conductors positioned in the slots with each of the plurality of conductors positioned radially outward from one of the plurality of bridges in the associated slot.

In at least one embodiment, an electric machine comprises a rotor and a stator separated from the rotor by an airgap. The stator comprises a stator core including a plurality of teeth with a plurality of slots formed between the teeth. A plurality of bridges are positioned in the plurality of slots. A concave recess is formed on a radially inward side of each of the plurality of bridges and a conductor cavity is formed on a radially outward side of each of the plurality of bridges. A winding arrangement is formed on the stator core, the winding arrangement including a plurality of conductors extending through the conductor cavities.

In at least one embodiment, a stator core comprises a plurality of teeth with a plurality of slots formed between the teeth. A plurality of bridges are positioned in the plurality of slots, and each of the plurality of bridges extends between two adjacent slots. A concave recess is formed on a radially inward side of each of the plurality of bridges and a conductor cavity is formed on a radially outward side of each of the plurality of bridges.

The above-described features and advantages, as well as others, will become more readily apparent to those of ordinary skill in the art by reference to the following detailed description and accompanying drawings. While it would be desirable to provide a stator for an electric machine that provides one or more of these or other advantageous features as may be apparent to those reviewing this disclosure, the teachings disclosed herein extend to those embodiments which fall within the scope of any eventually appended claims, regardless of whether they include or accomplish one or more of the advantages or features mentioned herein.

### BRIEF DESCRIPTION OF THE DRAWINGS

FIG. 1 shows a plan view of a limited portion of a stator core including bridges positioned in the slots;

FIG. 2 shows an outer perspective view of the stator core of FIG. 1;

FIG. 3 shows an inner perspective view of the stator core of FIG. 1;

FIG. 4 shows an outer perspective view of a first alternative embodiment of the stator core of FIG. 1;

FIG. 5 shows an inner perspective view of the first alternative embodiment of the stator core of FIG. 4 with hidden lines to illustrate positioning of bridges in the slots;

FIG. 6 shows a plan view of a second alternative embodiment of the stator core of FIG. 1;

FIG. 7 shows a plan view of a third alternative embodiment of the stator core of FIG. 1; and

FIG. 8 shows a plan view of a prior art IPM electric machine.

### DESCRIPTION

In the following detailed description, reference is made to the accompanying figures which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

A stator assembly 20 for an electric machine is disclosed herein and includes a stator core 22 with a winding arrangement 50 positioned thereon. The stator core 22 includes a plurality of teeth 24 with slots 26 formed between the teeth 24. Conductors 52 of the winding arrangement 50 extend through the slots 26. The stator core further includes slot bridges 40 that extend across the slots 26. The slot bridges are positioned radially inward from the conductors 52 of the winding arrangement. In at least one embodiment, the slots 26 are semi-open slots and the slot bridges 40 are further positioned radially outward from mincaps 30 positioned at the ends of the teeth 24.

Stator Core with Slot Bridges

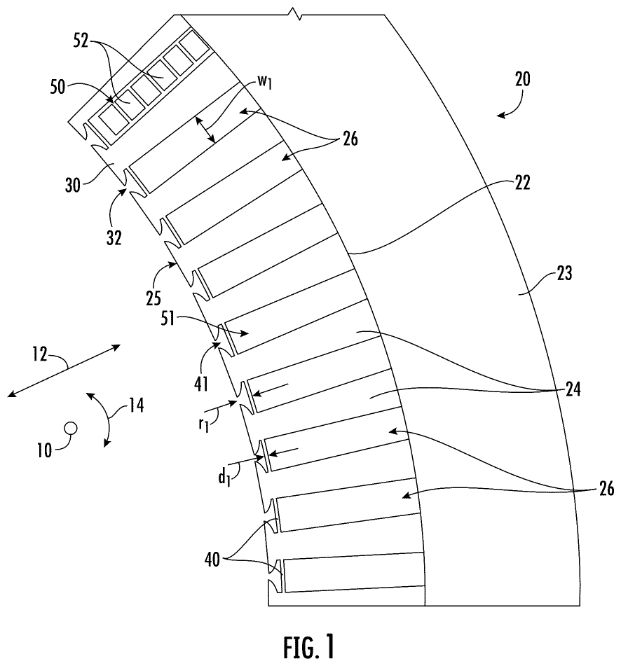

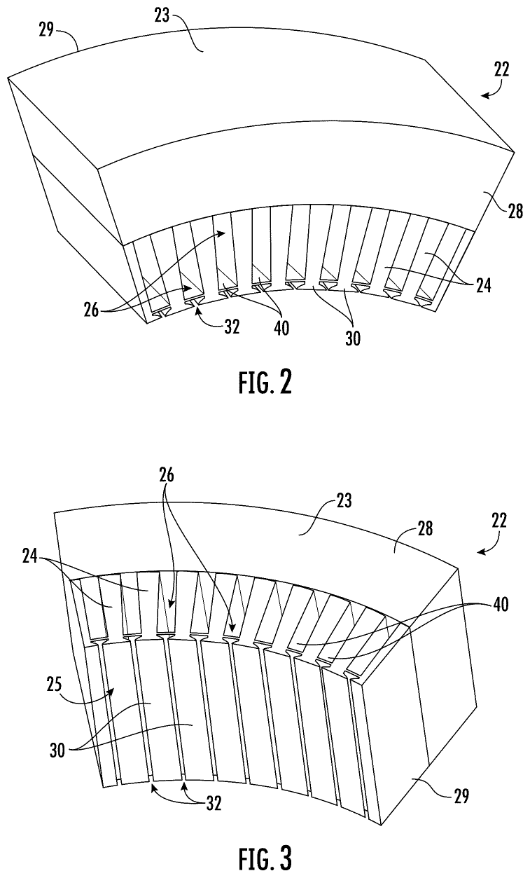

With particular reference now to FIGS. 1-3, the stator core 22 is provided by a unitary structure that forms a generally cylindrically-shaped component defined about a central axis (i.e., an axis that extends outward and inward from the page in FIG. 1, but the central axis itself is not shown in FIG. 1 because of space limitations). The stator core is comprised of a magnetic-permeable material, e.g., a ferromagnetic or other material such as iron, nickel, cobalt, and various alloys and steels containing these elements. It will be recognized that the term “magnetic permeable material” refers to any of the above-mentioned materials or other materials with a high magnetic permeability and which are recognized by those of ordinary skill in the art as being advantageous for use in association with a stator core.

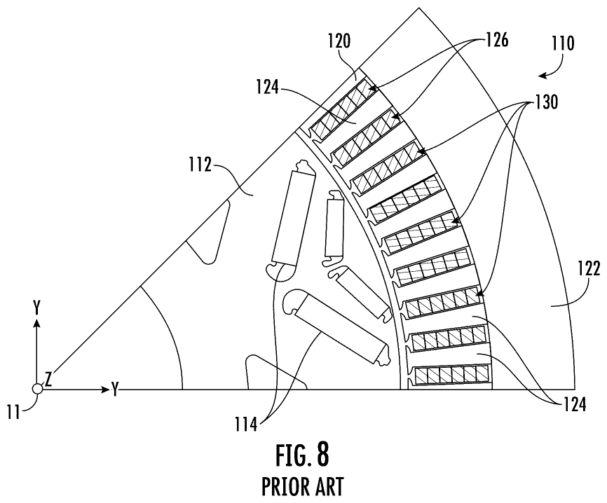

In many embodiments, the stator core 22 is formed from by sheets of material that are stacked upon one another and adhered or otherwise coupled together to form what is known as a “lamination stack.” However, in at least some embodiments, the stator core 22 is comprised of a monolithic structure (e.g., a molded structure). An axial direction on the stator is defined as a direction parallel to the central axis; a radial inward direction is defined as a direction towards the central axis of the stator core 22; a radial outward direction is defined as a direction away from the central axis; and a circumferential direction is defined is defined as a direction moving around the central axis. The axial direction is illustrated in FIG. 1 by the dot 10 that represents an axis extending outward and inward from the page. The radial direction is represented in FIG. 1 by the line segment with double arrows 12. The circumferential direction is represented in FIG. 1 by the arc with double arrows 14. Although the central axis is not shown in FIG. 1, it will be recognized that the central axis of a stator core is illustrated in FIG. 8 by the “z” axis 11 (with the “x” and “y” axis in FIG. 8 representing radial directions).

With continued reference to FIGS. 1-3, the stator core 22 includes a plurality of core slots 26 (or simply “slots”) formed between a plurality of teeth 24. The teeth 24 extend in a radial-inward direction from a circumferential outer-diameter wall 23 of the stator core 22. The core slots 26 extend between the outer-diameter wall 23 and slot openings formed at a circumferential inner diameter surface 25 of the stator core (i.e., the inner diameter surface 25 defined at the ends of the teeth 24). The core slots 26 and the teeth 24 also extend in the axial direction 10, parallel to the central axis of the stator core 22, between a first axial end 28 and a second axial end 29 of the stator core (i.e., the first end 28 opposite the second end 29 of the stator core in the axial direction). The core slots 26 and the associated teeth 24 are equally spaced around the circumferential inner diameter surface 25 of the stator core 22, and the respective inner surfaces of the teeth 24 extend axially parallel to the central axis.

In at least some embodiments, each tooth 24 of the stator core includes a minicap 30 positioned on the radially inward end of the tooth 24. The minicaps 30 are bulging portions/protuberances that extend circumferentially outward on opposing sides of each tooth 24 at the radially inward end of the tooth. Such protuberances may also be referred to as “feet” at the ends of a tooth. Opposing pairs of minicaps 30 on adjacent slot teeth form gateways to the slots that result in semi-closed slot openings 32 (which may also be referred to as “semi-open” slots). Accordingly, the circumferential width of each slot 26 is smaller at the minicaps 30 than at the more radially outward and/or central portions of the slot 26. For example, as shown in FIG. 1, the width of each slot 26 is less than “w₁” at the slot opening 32 along the circumferential inner surface 25 of the stator core 22 and is equal to “w₁” as indicated at a more central position of the slot 26. An exemplary description of such a stator core with minicaps is described in US Patent Publication No. 2024-0275228-A1, published on Aug. 15, 2024 (U.S. application Ser. No. 18/441,426), the entire contents of which are incorporated by reference herein.

Slot bridges 40 are positioned in each slot. Each slot bridge 40 is provided by a thin segment of magnetic permeable material that extends between two adjacent teeth 24 that form a slot 26. Accordingly, the slot bridges 40 have a circumferential width that is equal to that of the slot itself (i.e., w₁), but have a radial thickness dimension (d₁) that is much less than the circumferential width (w₁). For example, in at least some embodiments, w₁ is five to twenty times greater than d₁. Also, when the stator core 22 is provided by a lamination stack, the radial thickness d₁ of each of the plurality of bridges 40 may be between about 1.5 and two times a thickness of one lamination of the lamination stack (e.g., within a tolerance of +/−15% of 1.75 times the thickness of one lamination). Also, in at least some embodiments 0.3 mm≤d₁≤0.6 mm.

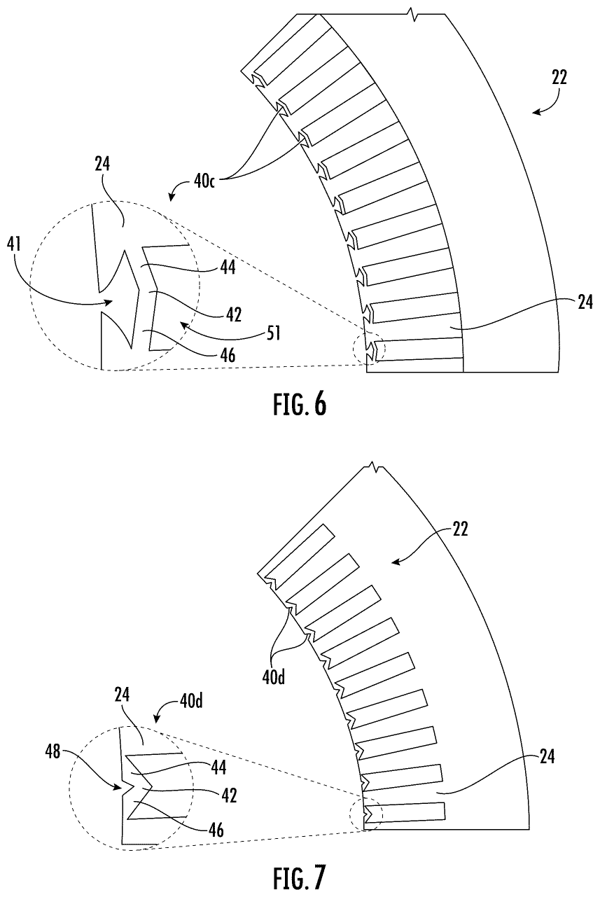

In the embodiment of FIGS. 1-3, the slot bridges 40 extend along the circumferential direction between adjacent teeth 24 without any radial directional component other than the radial thickness dimension (d₁) of the bridge 40. Accordingly, it will be recognized that the slot bridges 40 may be arced and generally defined along a radius with respect to the central axis of the stator core. In at least one embodiment, the slot bridges are not arced but extend along a straight line between two teeth 24. However, in other embodiments, the slot bridges 40 further include some radial directional component, such as that described in further detail below in association with FIGS. 6 and 7.

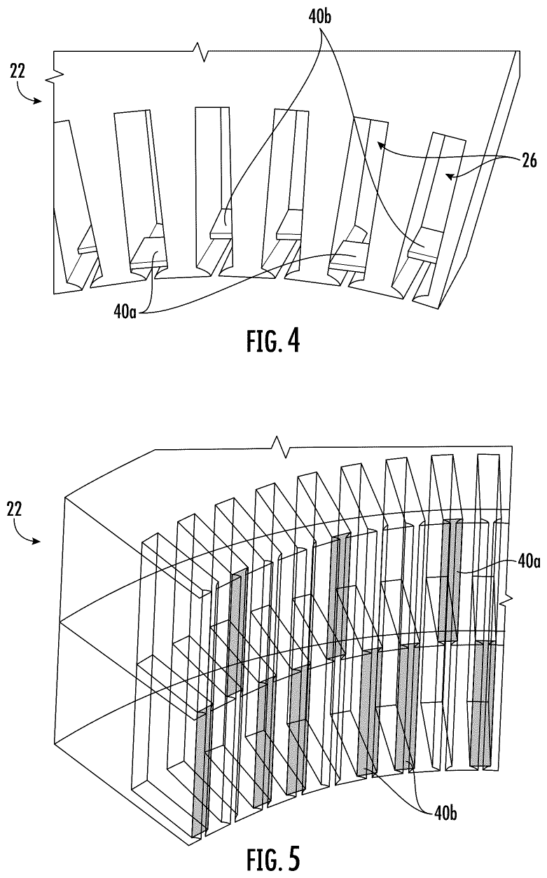

In addition to having a circumferential dimension (w₁) and a radial dimension (d₁), it will also be noted that the slot bridges 40 have an axial dimension. In the embodiment of FIGS. 1-3, the slot bridges extend in an axial direction for the full length of each slot 26 (i.e., between the first end 28 and the second end 29) of the stator core. However, it will be recognized that in at least some embodiments, the slot bridges 40 extend in an axial direction for less than the full axial length of the slot, as explained in further detail below in association with the embodiment of FIGS. 4 and 5.

With continued reference to the embodiment of FIGS. 1-3, it can be seen that the slot bridges 40 are positioned within the slots 26 radially inward from the conductors 52 of the winding arrangement 50, but radially outward from the ends of the teeth 24 along the inner diameter surface 25. Specifically, the slot bridges 40 are positioned radially outward from the minicaps 30 within the slots. Accordingly, each slot bridge 40 is positioned in the slot 26 at a radial distance “r₁” from the inner diameter surface 25, wherein r₁ is greater than the greatest radial dimension of the minicaps 30 at the end of the slot 26.

The slot bridges 40 may be provided in the slots in different configurations. In at least one embodiment, the slot bridges 40 are integrally formed with the teeth 24. Accordingly, each layer of a lamination stack that provides the stator core 22 may be stamped or otherwise formed to include the slot bridges 40 extending between the teeth 24. Alternatively, in at least one embodiment, the slot bridges 40 may be provided by separate segments of magnetic-permeable material that are added to the stator core 22 after the teeth of the stator core are formed. For example, the slot bridges 40 may be independent/separate pieces from the teeth 24 of the stator core 22, which separate pieces are adhered, welded, friction-fit, or otherwise arranged in the slots 26, with each slot bridge extending between two adjacent teeth 24 of the stator core 22.

The slot bridges advantageously connect adjacent pairs of stator teeth and provide several benefits. For example, each slot bridge 40 creates a short-circuit path for the electromagnetic flux to flow between an adjacent pair of stator teeth. Accordingly, the slot bridges may also be referred to as “short-circuit bridges.” As explained in further detail herein, these short circuit bridges 40 may advantageously reduce core losses, reduce the leakage flux going into slots of the stator core to reduce AC copper losses, and reduce noise within the electric machine by providing a stiffer stator structure.

### Winding Arrangement Positioned on Stator Core

As noted above, a winding arrangement 50 is provided on the stator core 22. The winding arrangement 50 is comprised of a plurality of conductors 52 that extend in an axial direction through the slots 26. The conductors 52 are only illustrated in one of the slots in FIG. 1 for the sake of simplicity. However, it will be recognized that conductors 52 are also positioned in the other slots 26 of the stator core 22. End turns (not shown) join conductors 52 in different slots. Together, the in-slot conductors 52 and the end turns form a complete winding arrangement for the stator 20.

The conductors 52 and end turns used to firm the winding arrangement 50 may be provided by any of various wires and wire segments as are commonly used to form windings for electric machines. For example, the winding arrangement may be provided by segmented conductors (or “hairpin” conductors that are inserted into the slots 26 in an axial direction. An exemplary description of a winding arrangement formed by segmented conductors is described in US Patent Publication No. 2023/0396115, (U.S. application Ser. No. 18/325,535), the entire contents of which are incorporated by reference herein.

In at least one embodiment, the conductors 52 in the slot are copper wires or wire segments having a generally rectangular shape. The conductors 52 may be insulated with an insulative coating (e.g., a polymer such as PVC or other material). While substantially rectangular conductors are shown in FIG. 1, it will be recognized that any of various shapes, sizes and forms of conductors may be used in the slots 26, as is common in the formation of stator windings, such as round conductors. The conductors 52 may be arranged in a single file row in each slot 26. For example, in at least some embodiments, six or eight conductors may extend through each slot, the conductors arranged in a single file row with each conductor associated with a “layer” of conductors within the slots. The width of each conductor 52 is less than the width of the associated slot (e.g., less than dimension “w₁” in FIG. 1).

### Alternative Embodiments of Slot Bridges

With reference now to FIGS. 4 and 5, in at least one alternative embodiment of the stator core 22, the slot bridges 40 may have a limited axial dimension (i.e., a limited axial depth) such that the slot bridges 40 extend for less than the full axial length of a slot 26. For example, each slot bridge 40 may extend in the axial direction for only half the axial depth of the associated slot 26. This embodiment is illustrated in FIGS. 4 and 5 by slot bridges 40a and 40b. In this embodiment, some of the slot bridges 40a are positioned on an upper/first axial half of the stator core 22, and other slot bridges 40b are positioned on a lower/second axial half of the stator core. The distribution of the slot bridges 40a and 40b between the first and second axial halves of the stator core 22 may be equal or unequal, but the spacing of the slot bridges is consistent. For example, in the embodiment of FIGS. 4 and 5, there are twice as many slot bridges 40b on the second axial half of the stator core as compared to the number of slot bridges 40a on the first half of the stator core, but the slot bridges 40a and 40 are all evenly spaced around the stator core (e.g., in a 1-2-1-2 pattern between the first and second halves of the stator core). This consistent spacing of the slot bridges 40a and 40b results in an arrangement that, depending on the application, may advantageously stiffen the stator to reduce noise and also offer reduced flux leakage and reduced core losses.

With reference now to the embodiments of FIGS. 6 and 7, in at least some alternative embodiments of the stator core 22, the slot bridges 40 are specially arced and/or angled. In these embodiments, the slot bridges 40c are neither linear nor follow a circumferential arc based on their distance from the central axis of the stator core. Instead, the slot bridges 40c have a special/unique shape. For example, a central section 42 of each slot bridge 40c may be specially arced based on an arc radius that is much less than the distance of the slot bridge 40c from the central axis (e.g., the arc radius of the central section 42 may be defined by a distance that is less than half the distance to the central axis). Furthermore, the opposing sides 44, 46 of the central section 42 may be individually linear, but angled with respect to one another. In the exemplary embodiment of FIG. 6, the central section 42 is specially arced, and the first circumferential side 44 of the slot bridge 40 is angled relative to the second circumferential side 46 of the slot bridge. In the exemplary embodiment of FIG. 7, the central section 42 of the slot bridge 40d is also specially arced but is based on a smaller radius than that of FIG. 6. Furthermore, in the exemplary embodiment of FIG. 7, the first side 44 is angled to a greater extent than that of the second side 44 (e.g., closer to a 90° angle). Also, in the exemplary embodiment of FIG. 7, the first side 44 and the second side of the slot bridge 40d are slightly tapered moving away from the teeth 24 and toward the central section 42 of the slot bridge 40c.

With continued reference to FIG. 7, in at least one alternative embodiment, the ends of each slot bridge 40d are connected to the radially inward ends of the adjacent teeth. In this embodiment, the distance r₁ is zero. The slot bridges 40d are angled such that concave dimples/cavities 48 are formed sequentially along the inner diameter 25 of the stator core. These dimples 48 are arranged at the ends of the slots 26 and extend in a radially outward direction toward the slots. In other words, the dimples 48 are positioned at locations where openings to the slots would be provided in other embodiments where the slots are semi-closed slots. This arrangement of FIG. 7 may further be viewed as an embodiment wherein the slot bridges are used to connect the minicaps, thus making a single structure that extends across the slot. This is an alternative to the embodiment of FIG. 6 wherein the slot bridges are distinct from the minicaps.

In each of the embodiments of FIGS. 1-7, it will be recognized that the slot bridges 40 separate the slots 26 into two distinct portions. First, each slot bridge 40 defines a conductor cavity 51 on a radially outward side of the slot bridge (i.e., the cavity 51 defined between the slot bridge 40 and the circumferential outer diameter wall 23). Second, each slot bridge 40 defines a concave recess 41 in an associated slot 26 on a radially inward side of the slot bridge (i.e., a recess that extends from the inner diameter surface 25 toward the circumferential outer-diameter wall 23). In some embodiments, the concave recesses are larger than others. For example, in the embodiment of FIG. 7, the concave recesses 41 are relatively small compared to the concave recesses of FIG. 1. More specifically, the relatively small dimples 48 serve as the concave recesses 41 in the embodiment of FIG. 7.

Operation of Electric Machine Including Stator with Slot Bridges

It will be recognized that the above-disclosed stator assembly may be used within an electric machine. Specifically, the stator assembly 20 may be used in an electric motor, wherein the stator assembly 20 is separated from a rotor by an airgap. The rotor may be any of various types of rotors, such as the rotor 112 of an IPM machine as shown in FIG. 8. However, it will be recognized that the stator assembly 20 may also be utilized in other types of electric machines, such as induction machines. In at least one application, the stator assembly 20 is particularly advantageous when used as a secondary drive unit in a BEV.

As noted previously herein, the stator assembly 20 advantageously provides for loss reduction and NVH improvement over conventional stator designs. This loss reduction is very useful for secondary drive unit applications. The bridges 40 in the stator design are advantageous in at least the following three ways: (1) they create a short-circuit path for the electromagnetic flux which can be used to reduce core losses, (2) they reduce the leakage flux going into slots to reduce AC copper losses, and (3) they reduce the noise with stiffer stator structure. Furthermore, the NVH reduction offered by the embodiments described herein allow the electric machine to perform efficiently with a wide range of operating speeds. This loss reduction is significant at the typical drive cycle for secondary-drive unit iDMs (integrated drive modules).

In addition to the above-noted advantages, additional advantages will also be recognized. For example, the stator assembly 20 is configured to reduce leakage flux into the slots and copper wires, and specifically reduce leakage flux at no load and light load conditions. The bridges 40 of the stator assembly provide additional structural support for the stator core and thereby reduce NVH. The bridges 40 extend across the slots while still enabling full oil cooling inside slots 26, and without the need to add additional seals in the slots. When used in association with segmented conductors, the bridges also provide support for the segmented conductors.

In testing, stator assembly 20 shows more than 10% reduction in no-load core losses and drag losses. The stator assembly also shows a 10% reduction in AC copper loss with sinusoidal input, and 15% reduction with PWM (pulse width modulation) loss inputs. Exemplary NVH benefits also show in testing, including up to 5 dB equivalent radiation power (ERP) reduction is observed at dominant mechanical orders (24th, 48th and 72nd). This reduction may be credited at least in part to increased stiffness in the tangential direction. The benefit may also be higher for induction machines, where electromagnetic forces in tangential direction contribute more to noise and vibration level than IPM machines.

Although various embodiments of the stator assembly with slot bridges have been described herein, it will be appreciated by those of skill in the art that other implementations and adaptations are possible. Furthermore, aspects of the various embodiments described herein may be combined or substituted with aspects from other features to arrive at different embodiments from those described herein. Thus, it will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by any eventually appended claims.

What is claimed is:

1. A stator for an electric machine comprising:
a stator core defining an axial direction, a first end, and a second end, the stator core including:
an outer diameter wall;
a plurality of teeth extending radially inward from the outer diameter wall with a plurality of slots defined between the teeth; and
a plurality of bridges positioned in the plurality of slots, each of the plurality of bridges extending across a circumferential width of an associated slot;
wherein each of the outer diameter wall, the plurality of teeth and the plurality of bridges are comprised of a magnetic permeable material; and
a winding arrangement arranged on the stator core, the winding arrangement comprising a plurality of conductors positioned in the slots, each of the plurality of conductors positioned radially outward from one of the plurality of bridges in the associated slot.

2. The stator of claim 1 further comprising minicaps positioned at radially inward ends of teeth and extending in a circumferential direction, wherein the minicaps define semi-open slots, and wherein the bridges are positioned radially outward from the minicaps.

3. The stator of claim 1 wherein the plurality of bridges are integrally formed with the plurality of teeth.

4. The stator of claim 1 wherein a radial thickness of each of the plurality of bridges is less than a circumferential width of the associated slot.

5. The stator of claim 4 wherein the stator core is provided by a lamination stack, and wherein the radial thickness of each of the plurality of bridges is between 1.5 and two times a thickness of one lamination of the lamination stack.

6. The stator of claim 4 wherein the radial thickness is between 0.3 mm and 0.6 mm.

7. The stator of claim 1 wherein each of the plurality of bridges has a limited axial depth in the associated slot that is less than a distance from the first end to the second end of the associated slot.

8. The stator of claim 7 wherein the plurality of bridges include a first plurality of bridges arranged on a first axial half of the stator core and a second plurality of bridges arranged on a second axial half of the stator core.

9. The stator of claim 1 wherein each of the plurality of bridges includes a first circumferential side and a second circumferential side, wherein the first circumferential side is angled relative to the second circumferential side.

10. The stator of claim 9 wherein the first circumferential side is separated from the second circumferential side of each bridge by a central section, wherein the central section is an arced section defined by a radius that is less than a distance from the bridge to a central axis of the stator core.

11. The stator core of claim 9 wherein each bridge is connected to radially inward ends of adjacent teeth, and wherein dimples are formed along an inner diameter of the stator core by the bridges.

12. An electric machine comprising:
a rotor; and
a stator separated from the rotor by an airgap, the stator comprising:
a stator core including a plurality of teeth with a plurality of slots formed between the teeth;
a plurality of bridges positioned in the plurality of slots, wherein a concave recess is formed on a radially inward side of each of the plurality of bridges and a conductor cavity is formed on a radially outward side of each of the plurality of bridges; and
a winding arrangement formed on the stator core, the winding arrangement including a plurality of conductors extending through the conductor cavities.

13. The electric machine of claim 12, the stator core further comprising a plurality of minicaps positioned at ends of the plurality of teeth, wherein each of the plurality of bridges is positioned radially outward from an associated pair of the plurality of minicaps.

14. The electric machine of claim 12 wherein each of the plurality of bridges is defined by an axial depth that is less than an axial depth of each of the plurality of slots.

15. The electric machine of claim 12 wherein each of the plurality of bridges includes a first circumferential side and a second circumferential side, wherein the first circumferential side is angled relative to the second circumferential side.

16. The electric machine of claim 12 wherein the electric machine is an interior permanent magnet (IPM) machine.

17. A stator core comprising:
a plurality of teeth with a plurality of slots formed between the teeth; and
a plurality of bridges positioned in the plurality of slots, each of the plurality of bridges extending between two adjacent slots, wherein a concave recess is formed on a radially inward side of each of the plurality of bridges and a conductor cavity is formed on a radially outward side of each of the plurality of bridges.

18. The stator core of claim 17 wherein the plurality of bridges are integrally formed with the plurality of teeth.

19. The stator core of claim 17 further comprising a plurality of minicaps positioned at ends of the plurality of teeth, wherein each of the plurality of bridges is positioned radially outward from an associated pair of the plurality of minicaps.

20. The stator core of claim 17 wherein each of the plurality of bridges is defined by an axial depth that is less than an axial depth of each of the plurality of slots.
